(19) United States
(12) Patent Application Publication
(10) Pub. No.: US 2017/0087931 A1
(43) Pub. Date: Mar. 30, 2017

(54) THERMOPLASTIC WHEEL HUB AND NON-PNEUMATIC TIRE

(71) Applicants: Ryan Michael GAYLO, Greenville, SC (US); Timothy Brett RHYNE, Greenville, SC (US); Steven M. CRON, Greenville, SC (US); Clayton BOHN, JR., Greenville, SC (US); Prasanna KONDAPALLI, Greenville, SC (US); Stephen SERNA, Greenville, SC (US); William MCMASTER, Greenville, SC (US); Compagnie Generale des Etablissements Michelin, Clermont-Ferrand (FR); Michelin Recherche et Technique S.A., Granges-Paccot (CH)

(72) Inventors: Ryan Michael GAYLO, Simpsonville, SC (US); Timothy Brett RHYNE, Greenville, SC (US); Steven M CRON, Simpsonville, SC (US); Clayton C BOHN, JR., Mauldin, SC (US); Prasanna KONDAPALLI, Ypsilanti, MI (US); Stephen SERNA, Hopatcong, NJ (US); William McMASTER, Berkeley Heights, NJ (US)

(21) Appl. No.: 15/311,822

(22) PCT Filed: May 16, 2014
(86) PCT No.: PCT/US2014/038456

§ 371 Date: Nov. 16, 2016

(51) Int. Cl. B60B 5/02; B60B 9/26; B60B 27/06; B60C 7/14; B60C 7/24

(52) U.S. Cl. CPC B60B 5/02; B60C 7/14; B60C 7/24; B60B 27/065; B60B 9/26; B60C 2007/146; B29C 45/174

(57) ABSTRACT

A non-pneumatic wheel having a thermoplastic wheel hub includes a center hub for attachment to a wheel bearing of a vehicle. The center hub has a central shaft aperture extending axially therethough and a plurality of lug apertures spaced radially from and circumferentially about the central shaft aperture. The thermoplastic wheel hub also includes a plurality of ribs extending radially outwardly from the center hub. The thermoplastic wheel hub further includes a cylindrical tire mount connected to the ribs and extending axially in substantially a cylinder for mounting a non-pneumatic tire thereon.

### BACKGROUND OF THE INVENTION

1. Field of the Invention

The present invention relates generally to non-pneumatic tires and, more particularly, to a non-pneumatic wheel having a thermoplastic wheel hub that can support a load and have performance similar to pneumatic tires.

2. Description of the Related Art

It is known to provide a wheel for a vehicle. Typically, the wheel includes a wheel hub mounted to a wheel bearing and axle of the vehicle and an inflatable or pneumatic tire mounted to the wheel hub. Recently, some wheels have been provided with a non-pneumatic or non-inflatable tire mounted to the wheel hub. Non-pneumatic tires, such as the TWEEL® non-pneumatic tire, are not inflatable. Typically, the non-pneumatic tire has an inner interface band portion for engaging the outer surface of the wheel hub and a plurality of spokes or web elements surrounding the inner interface band portion. The non-pneumatic tire also has an outer band concentrically positioned outside the inner interface band portion and positioned at the outer end of the spokes or web elements, forming an outer edge of the tire. The outer band includes a tread for contact with a surface against which it rolls, such as the surface of a road. The non-pneumatic tire supports its load solely through the structural properties of its tread, outer band, and spokes or web elements without support from internal air pressure.

Such non-pneumatic tires are mounted on a conventional wheel hub. The wheel hub is typically made of a metal material. The wheel hub includes a central disc provided with a central hole and may have a plurality of lug holes for receiving threaded fasteners such as bolts or studs of the wheel bearing. These metal wheel hubs are typically designed to meet load and structural requirements of an inflatable or pneumatic tire. In addition, these metal wheel hubs add significant weight to the wheel, resulting in additional weight for the vehicle.

It is, therefore, desirable to provide a non-pneumatic wheel having a thermoplastic wheel hub and a non-pneumatic tire mounted thereon. It is also desirable to provide a non-pneumatic wheel having a thermoplastic wheel hub that meets load and structural requirements of the non-pneumatic tire. It is further desirable to provide a non-pneumatic wheel having a thermoplastic wheel hub that reduces weight compared to conventional wheel hubs for a non-pneumatic tire. As such, there is a need in the art to provide a non-pneumatic wheel having a thermoplastic wheel hub that meets at least one of these desires.

### SUMMARY OF THE INVENTION

Accordingly, the present invention is a non-pneumatic wheel having a thermoplastic wheel hub including a center hub for attachment to a wheel bearing of a vehicle. The center hub includes a central shaft aperture extending axially therethrough and a plurality of lug apertures spaced radially from and circumferentially about the central shaft aperture. The thermoplastic wheel hub also includes a plurality of ribs extending radially outwardly from the center hub. The thermoplastic wheel hub further includes a cylindrical tire mount connected to the ribs and extending axially in substantially a cylinder for mounting a non-pneumatic tire thereon.

The term “vehicle” is used herein for the purposes of the description; however, any device on which compliant wheels could be mounted is included in the following description and “vehicle” should be understood to include the same.

In an exemplary embodiment a thermoplastic wheel hub is provided for mounting a non-pneumatic tire thereon. In another exemplary embodiment the thermoplastic wheel hub meets load and structural requirements for braking, cornering, fatigue, impact, etc. Yet in another exemplary embodiment the thermoplastic wheel hub incorporates compression limiters to help support loads in high stress areas. Still in another exemplary embodiment the thermoplastic wheel hub uses structural ribs to distribute the loads throughout the wheel hub. In a further exemplary embodiment the thermoplastic wheel hub has rib thickness and placement for both strength and appearance, minimizing sink marks. Yet in a further exemplary embodiment the thermoplastic wheel hub has a uniform wall thickness to provide dimensional stability and weight reduction. Still in a further exemplary embodiment the thermoplastic wheel hub reduces weight compared to conventional wheel hubs.

The features of the embodiments as disclosed herein may be combined with each other or with new embodiment features to create yet additional embodiments within the scope of the invention.

Features and advantages of other embodiments will be readily appreciated, as the same becomes better understood, after reading the subsequent description taken in conjunction with the accompanying drawings.

### BRIEF DESCRIPTION OF THE DRAWINGS

FIG. 1 is a front elevational view of one embodiment of a thermoplastic wheel hub, according to the present invention, illustrating a non-pneumatic tire mounted thereon and mounted to a wheel bearing and axle of a vehicle in phantom.

FIG. 1A is an exploded perspective view of the thermoplastic wheel hub of FIG. 1 without the non-pneumatic tire mounted thereon.

FIG. 2 is a front perspective view of the thermoplastic wheel hub of FIG. 1 without compression limiters.

FIG. 3 is a rear perspective view of the thermoplastic wheel hub of FIG. 1 without compression limiters.

FIG. 4 is a front elevational view of the thermoplastic wheel hub of FIG. 1.

FIG. 5 is a side elevational view of the thermoplastic wheel hub of FIG. 1.

FIG. 6 is a rear elevational view of the thermoplastic wheel hub of FIG. 1.

FIG. 7 is a cross-sectional view taken along line 7-7 of FIG. 4.

FIG. 8 is a cross-sectional view taken along line 8-8 of FIG. 4.

FIG. 9 is a front elevational view of one embodiment of a compression limiter, according to the present invention, of the thermoplastic wheel hub of FIGS. 1 through 8.

FIG. 10 is a side elevational view of the compression limiter of FIG. 9.

FIG. 11 is a cross-sectional view taken along line 11-11 of FIG. 9.

FIG. 12 is a front elevational view of another embodiment of a compression limiter, according to the present invention, of the thermoplastic wheel hub of FIGS. 1 through 8.

FIG. 13 is a side elevational view of the compression limiter of FIG. 12.

FIG. 14 is a cross-sectional view taken along line 14-14 of FIG. 12.

### DETAILED DESCRIPTION OF THE PREFERRED EMBODIMENT(S)

The present invention provides a non-pneumatic wheel having a thermoplastic hub assembly that can support a load and have performance similar to pneumatic tires. Various configurations of a non-pneumatic wheel, including variations of the thermoplastic hub assembly, are provided.

For purposes of describing the invention, reference now will be made in detail to embodiments and/or methods of the invention, one or more examples of which are illustrated in or with the drawings. Each example is provided by way of explanation of the invention, not limitation of the invention. In fact, it will be apparent to those skilled in the art that various modifications and variations can be made in the present invention without departing from the scope or spirit of the invention. For instance, features or steps illustrated or described as part of one embodiment, can be used with another embodiment or steps to yield still further embodiments or methods. Thus, it is intended that the present invention covers such modifications and variations as come within the scope of the appended claims and their equivalents.

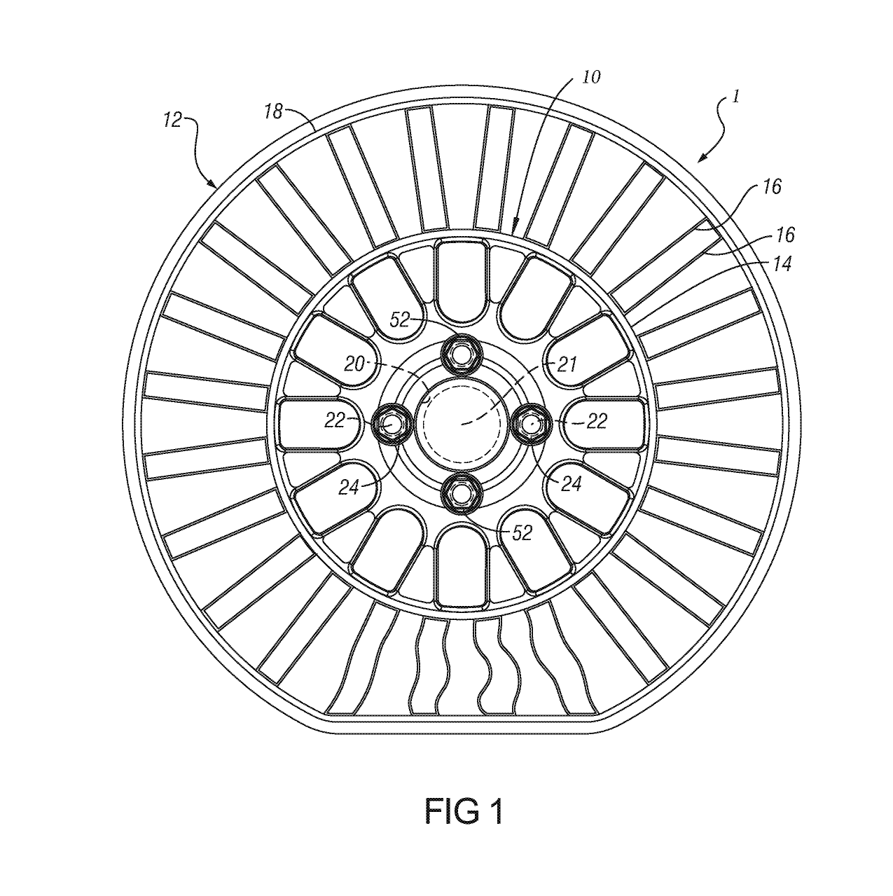

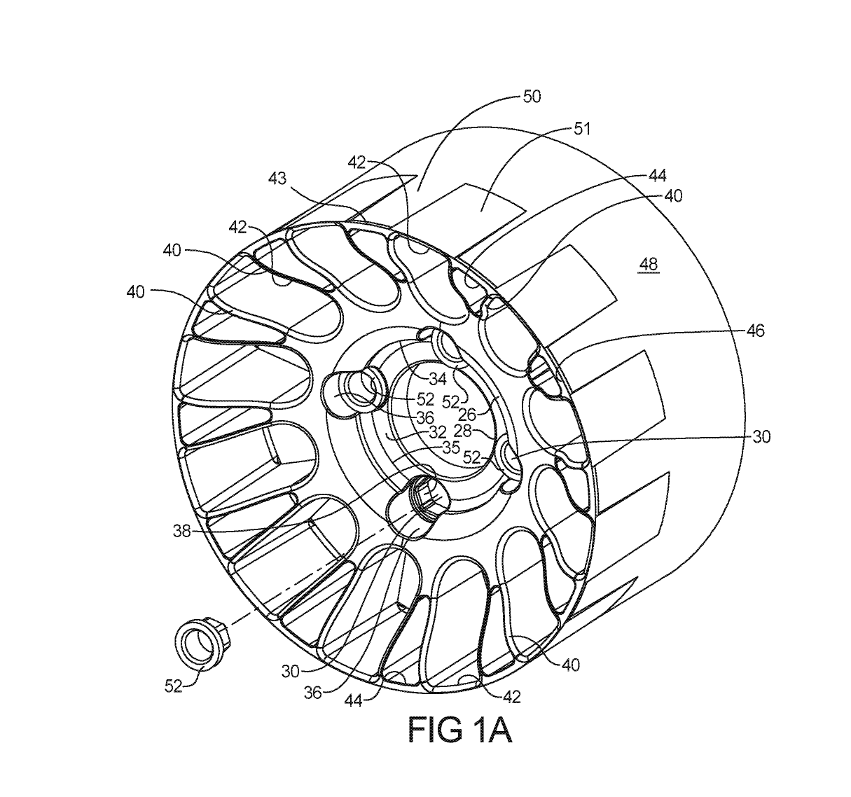

Referring to the figures, wherein like numerals indicate like parts throughout the several views, an embodiment of a non-pneumatic wheel having a thermoplastic wheel hub, according to the present invention, is shown generally at 1. The thermoplastic wheel hub 10 of the non-pneumatic wheel is configured to have a non-inflatable or non-pneumatic tire, generally indicated at 12, mounted thereon to form a wheel for a vehicle (not shown). As illustrated in FIG. 1, the non-pneumatic tire 12 includes an annular inner band 14, a plurality of spokes or web elements 16 arranged circumferentially about the inner band 14, and an annular outer band 18 disposed across the spokes or web elements 16, forming an outer edge of the tire 12. The outer band 18 includes a tread (not shown) for contact with a surface of a road. The non-pneumatic tire 12 supports it load solely through the structural properties of its tread, outer band 18, spokes or web elements 16, and inner band 14, without support from internal air pressure. The non-pneumatic tire 12 is mounted to the thermoplastic wheel hub 10, which is, in turn, mounted to a wheel or axle bearing 20 (partially shown) of the vehicle. The wheel bearing 20 has a shaft or axle 21 and a plurality of threaded lugs 22 that extend through the thermoplastic wheel hub 10 and the thermoplastic wheel hub 10 is secured to the wheel bearing 20 by fasteners 24 such as threaded nuts threadably engaging the lugs 22. As the wheel bearing rotates 20, the thermoplastic wheel hub 10 rotates, in turn, rotating the non-pneumatic tire 12. It should be appreciated that the non-pneumatic tire 12 illustrated in FIG. 1 is known in the art as the TWEEL® non-pneumatic tire, which is commercially available from Michelin North America, Inc. It should also be appreciated that the specific embodiment of the non-pneumatic tire 12 illustrated in FIG. 1 is not intended to limit the scope of the present invention. It should further be appreciated that the thermoplastic wheel hub 10 may operate with various other types of non-inflatable or non-pneumatic tires, not specifically shown herein, without departing from the scope of the present invention.

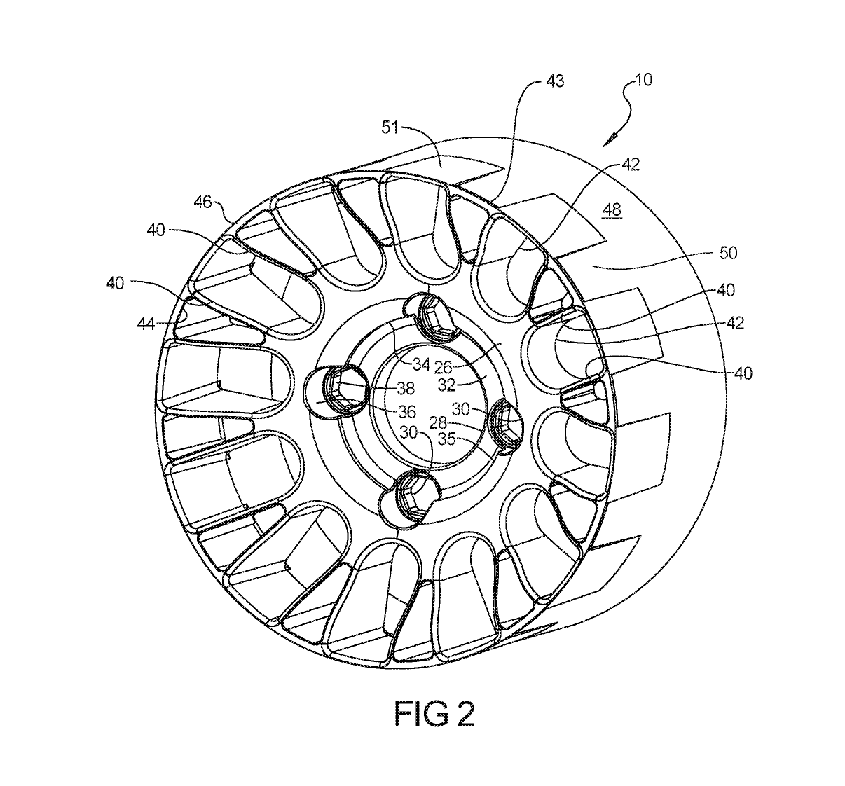

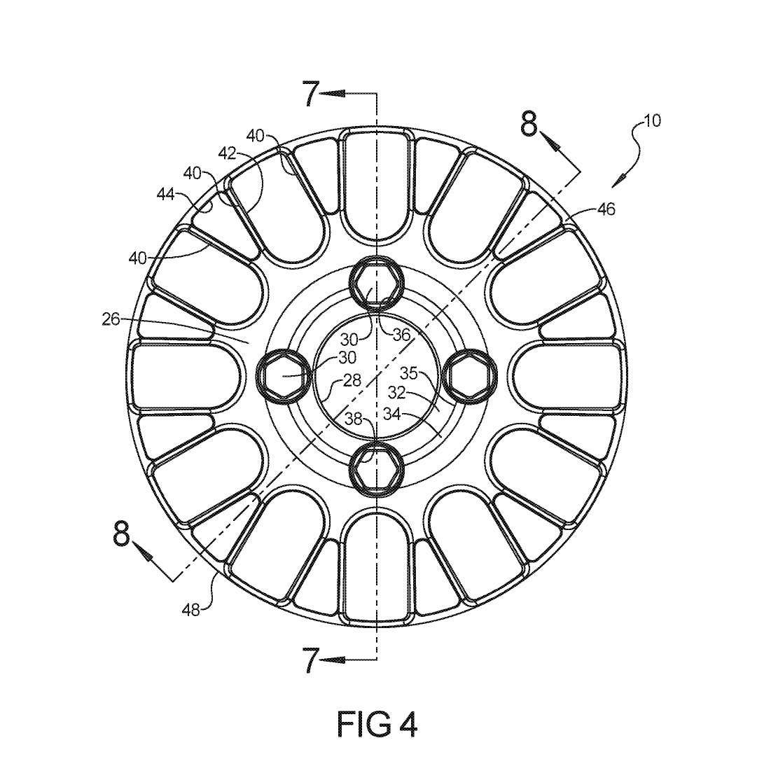

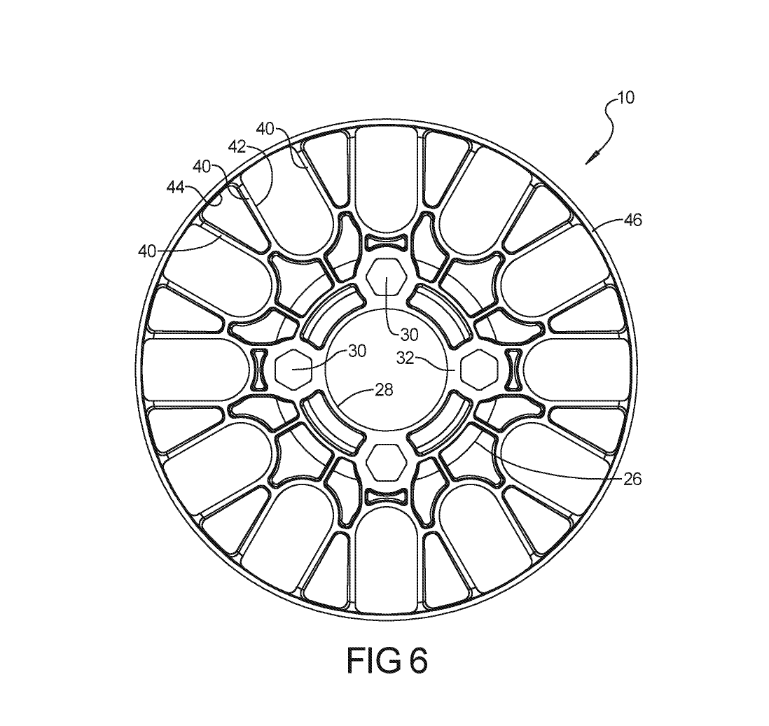

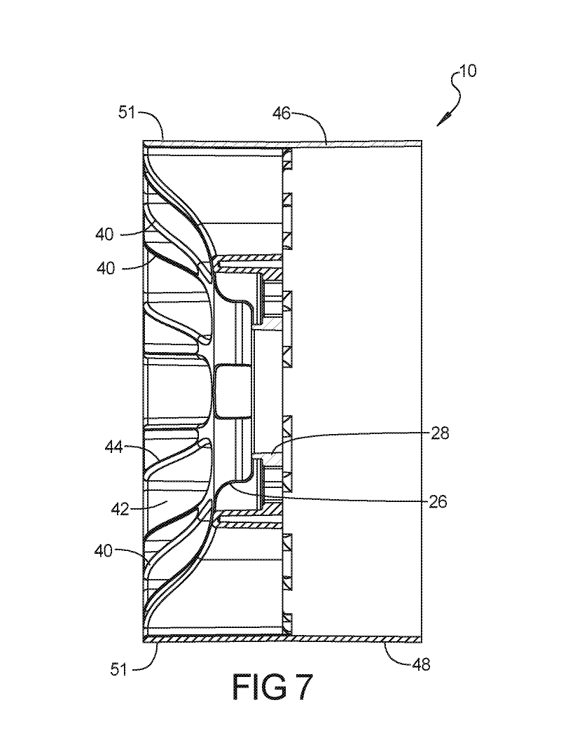

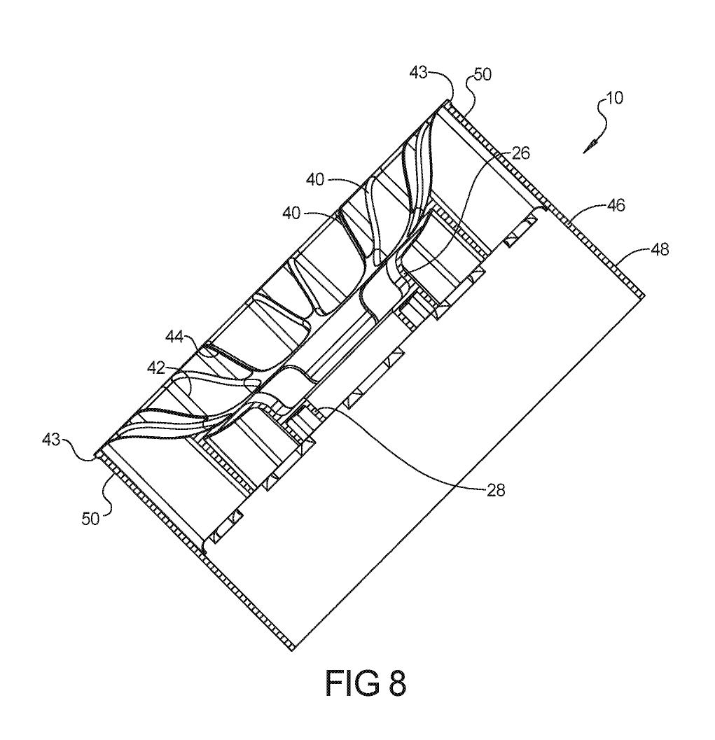

In FIGS. 1A through 8 the non-pneumatic tire portion of the non-pneumatic wheel is not shown for clarity of illustrating the hub portion 10. The thermoplastic wheel hub 10 of the non-pneumatic wheel includes a center hub 26 for attachment to the wheel bearing 20. The center hub 26 is generally circular in shape. The center hub 26 has a central shaft aperture 28 extending axially therethough and a plurality of lug apertures 30 spaced radially from and circumferentially about the central shaft aperture 28. The lug apertures 30 extend axially through the center hub 26. The center hub 26 has a base wall 32 extending radially and circumferentially and a side wall 34 extending circumferentially and axially about the base wall 32 to form a recess 35. As illustrated, the central shaft aperture 28 extends axially though the base wall 32 and the lug apertures 30 extending axially through the base wall 32 and the side wall 34. Each of the lug apertures 30 have a recessed portion 36 in the base wall 32 and the side wall 34 and a through portion 38 extending from the recessed portion 36. As illustrated, the recessed portion 36 is generally circular in shape and the through portion 38 is generally hexagonal in shape. It should be appreciated that the portions 36 and 38 may have any suitable shape. It should also be appreciated that, when the central hub 26 is mounted to the wheel bearing 20, a portion of the shaft 21 extends axially through the central shaft aperture 28 and the lugs 24 extend axially through the lug apertures 30.

The non-pneumatic wheel 1 as shown in FIG. 1 has an annular band 18 and a plurality of tension transmitting elements 16, illustrated as web spokes or web elements 16, extending transversely across and inward from band 18, to a mounting band 14 at the radially inner end of the web spokes 16. Inner mounting band 14 anchors wheel 12 to the hub 10. A tread portion is formed at the outer periphery of band 18. The tread portion may be an additional layer bonded on the band 18, for example, to provide different traction and wear properties than the material used to construct band 18. Alternatively, tread portion may be formed as part of the outer surface of the compliant band. Tread features may be formed in the tread portion and may include blocks and grooves.

As mentioned, web elements 16 in the exemplary embodiment of FIG. 1 extend transversely across wheel 1, which, as used herein means that the web elements 16 extend in a direction oriented from side to side of wheel 1 and may be aligned with the axis of rotation, or may be oblique to the wheel axis. Further, “extending inward” means that web elements 16 extend between outer band 18 and mounting band 14, and may lie in a plane radial to the wheel axis or may be oblique to the radial plane. In addition, as shown in FIG. 1, web elements 16 may actually include spokes at different angles to the radial plane. The web elements 16 may be interconnected with each other. Various shapes and patterns may be used as shown, e.g., in U.S. Pat. No. 7,013,939.

Band 18 supports the load on wheel 1 and resiliently deforms to conform to the road (or other supporting surface) to provide traction and handling capabilities. More particularly, as described in U.S. Pat. No. 7,013,939, when a load is placed on the wheel 1 through hub 10, band 18 acts compliantly in that it bends and otherwise deforms for ground contact and forms a contact patch. A “contact patch” is the portion of wheel 1 that is in contact with the ground under a load. The portion of band 18 that is not in ground contact acts in a manner similar to an arch and provides circumferential compression stiffness and a longitudinal bending stiffness in the equatorial plane sufficiently high to act as a load-supporting member. As used herein, “equatorial plane” means a plane that passes perpendicular to the wheel axis of rotation and bisects the wheel structure.

The load on the wheel 1, transmitted from the vehicle (not shown) to hub 10 essentially hangs by web spokes 16 attached to the load supporting portion of band 18. Web elements 16 in the ground contacting region do not experience tensile loading due to the load. As wheel 1 rotates, of course, the specific portion of the compliant band 18 acting as an arch continually changes, however, the concept of an arch is useful for understanding the load supporting mechanism. The amount of bending of band 18, and accordingly, the size of the contact patch is proportional to the load. The ability of band 18 to bend resiliently under the load provides a compliant ground contact area that acts similar to that of a pneumatic tire, with similar advantageous results.

For example, band 18 can envelop obstacles to provide a smoother ride. Also, band 18 is able to transmit forces to the ground or road for traction, cornering, and steering. By contrast, in typical solid and cushion tires, the load is supported by compression of the tire structure in the contact area, which includes compression of the cushion material under the rigid hub. Compliance of the cushion material is limited by the compression properties of the material and the thickness of the material on the rigid wheel or hub.

Still referring to FIGS. 1, web elements 16 of this particular embodiment are substantially sheet-like elements having a length L in the radial direction, a width W in the axial direction corresponding generally to the axial width of the compliant band 18, although other widths W may be used including widths W that vary along the radial direction. Web elements 16 also have a thickness (i.e. a dimension perpendicular to length L and width W) that is generally much less than either the length L or the width W, which allows a web spoke to buckle or bend when under compression. Thinner web spokes will bend when passing through the contact area with substantially no compressive resistance, that is, supplying no or only insignificant compressive force to load bearing. As the thickness of web elements 16 is increased, the web elements may provide some compressive load bearing force in the ground contact area. The predominant load transmitting action of web elements 16 as a whole, however, is in tension. The particular web spoke thickness may be selected to meet the specific requirements of the vehicle or application.

As seen in FIG. 1, preferably, web elements 16 are oriented relative to the compliant band 18 across the axial direction. Tension in web elements 420 is, therefore, distributed across band 18 to support the load. By way of example, web elements 16 may be formed of an elastomeric material having a tensile modulus of about 10 to 100 MPa. Web elements 16 may be reinforced if desired. The material used to construct web element material 16 should also exhibit elastic behavior to return to original length after being strained to e.g., 30%, and to exhibit constant stress when the web spoke material is strained to e.g., 4%. For example, commercially available rubber or polyurethane materials can be identified which meet these requirements. By way of further example, Vibrathane B836 brand urethane from Chemtura Corporation of Middlebury, Conn. has been suitable for construction of web elements 16.

For the exemplary embodiment of FIGS. 1, web elements 16 are interconnected by radially inner mounting band 14, which encircles the hub 10 to mount wheel 1 to the hub 10. Depending on the construction materials and manufacturing process, hub 10, mounting band 14, annular band 18, and web elements 16 may be molded as single unit. Alternatively, one or more of such components may be formed separately and then attached to each other through e.g., adhesives or molding. Additionally, other components may be included as well. For example, an interface band can be used to connect web elements 16 at their radially outer ends, and then the interface band would be connected to band 18.

According to a further embodiment, web elements could be mechanically attached to hub 10, for example, by providing an enlarged portion on the inner end of each web element 16 that engages a slot or groove in the hub 10, or by attaching adjacent web element 16 to form a loop at a hook or bar formed in hub 10.

Substantially purely tensile load support is obtained by having a web element 16 that has high effective stiffness in tension but very low stiffness in compression. To facilitate bending in a particular direction, web elements 16 may be curved. Alternatively, web elements 16 can be molded with a curvature and straightened by thermal shrinkage during cooling to provide a predisposition to bending in a particular direction.

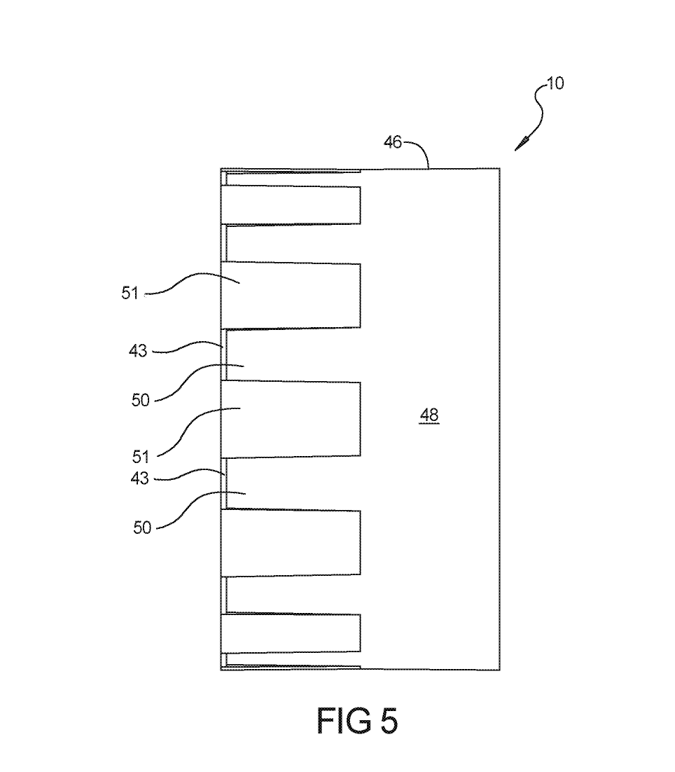

Web elements 16 should resist torsion between annular band 18 and hub 10, for example, when torque is applied to wheel 1. In addition, web elements 16 should resist lateral deflection when, for example, turning or cornering. As will be understood, web elements 16 that lie in the radial-axial plane, that is, are aligned with both the radial and axial directions, will have high resistance to axially directed forces, but, particularly if elongated in the radial direction, may have relatively low resistance to torque in the circumferential direction. For certain vehicles and applications, for example, those producing relatively low torque, a web spoke package having relatively short elements 16 aligned with the radial elements 16 will be suitable. For applications where high torque is expected, one of the arrangements such as shown in FIGS. 5 through 8 of U.S. Pat. No. 7,013,939 may be more suitable. In the variations shown therein, orientations of web spokes are provided that include a force-resisting component in both the radial and the circumferential directions, thus adding resistance to torque, while retaining radial and lateral force-resisting components. The angle of orientation may be selected depending on the number of web spokes used and the spacing between adjacent web spokes. Other alternative arrangements may also be used.

One advantage of the compliant wheel of the invention is that the selection of the size and arrangement of band 18 and web elements 16 allows the vertical, lateral, and torsional stiffness of the wheel to be tuned independently of the contact pressure and of each other. The operating parameters of band 18, load carrying and compliance, are determined in part by selection of materials having the circumferential compression stiffness and longitudinal bending stiffness in the equatorial plane to meet the design load requirements. These parameters are examined in view of the diameter of wheel 1, the width of annular band 18 in the axial direction, the thickness of band 18 in radial direction, and the length and spacing of web elements 16. The number of web spokes is selected to maintain circularity of band 18, and will depend also on the spacing between adjacent web elements 16.

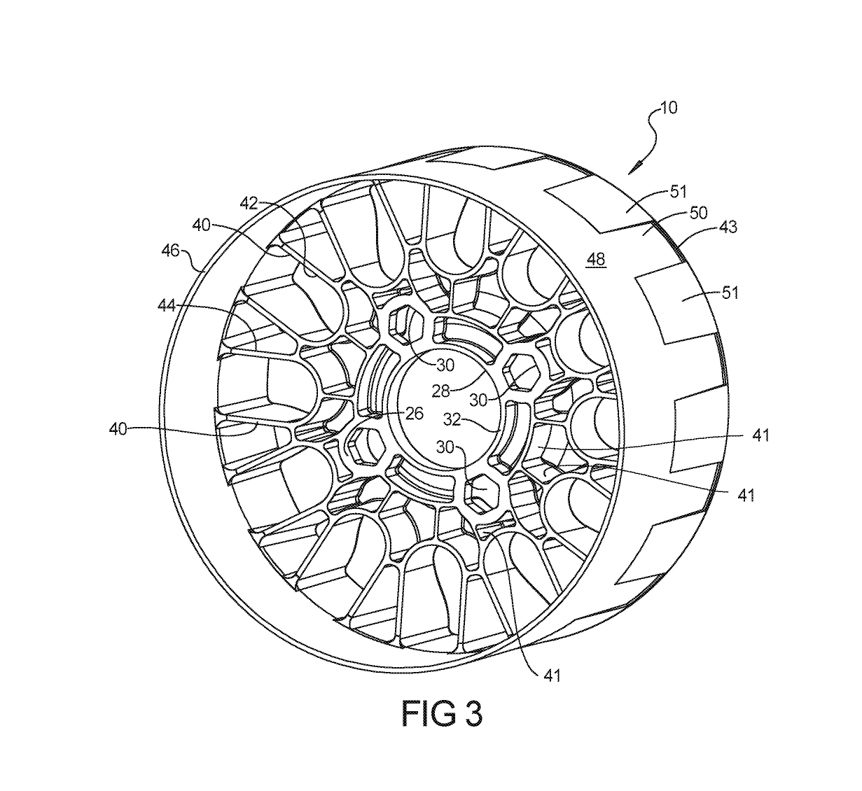

FIG. 3 shows the rear perspective view an embodiment of the nonpneumatic wheel hub 10. FIG. 3 shows the embodiment without the compression limiters or the non-pneumatic tire portion. In this embodiment, reinforcement ribs 41 have a reduced uniform wall thickness in aesthetic areas. The reduced uniform wall thickness of the reinforcement ribs 41 prevents sink marks on the aesthetic areas, such as on the front of the hub, which may occur from contraction of the hub material during the molding process.

The thermoplastic wheel hub 10 of this embodiment also includes a plurality of ribs 40 extending radially outwardly from the center hub 26. The ribs 40 include at least one or more pair of the ribs 40 extending radially between the center hub 26 and a tire mount 46 to be described and spaced circumferentially from each other to form a generally U-shaped aperture 42 therebetween. The ribs 40 also extend axially between the center hub 26 and the tire mount 46. In one embodiment, the ribs 40 have a uniform wall thickness. In the embodiment illustrated, a plurality of the pair of the ribs 40 are spaced circumferentially about the center hub 26 and form generally triangular shaped apertures 44 with one of the apertures 44 between each of the pair of the ribs 40. The center hub 26 is cantilevered by the ribs 40 to the tire mount 46. The center hub 26 is recessed axially relative to an outer axial periphery of the tire mount 46. It should be appreciated that the ribs 40 may be formed in other suitable patterns.

The thermoplastic wheel hub 10 further includes a cylindrical tire mount 46 extending circumferentially about and connected to the ribs 40. The tire mount 46 extends axially in substantially a cylinder for mounting the non-pneumatic tire 12 thereon. In one embodiment, the tire mount 46 has a substantially uniform wall thickness. In another embodiment, the tire mount 46 has a non-smooth outer tire mounting surface 48. The non-smooth outer tire mounting surface 48 is adapted for adhering the non-pneumatic tire 12 thereon by at least one of a surface roughness, mechanical bonding, surface treatment, and/or adhesion promoter. In one embodiment, the non-smooth outer tire mounting surface 48 includes at least one or more grooves 50 extending radially inward and axially and circumferentially along the tire mounting surface 48 for adhering the non-pneumatic tire 12 thereon. In the embodiment illustrated, the non-smooth outer tire mounting surface 48 includes a plurality of the grooves 50 being generally rectangular in shape and spaced circumferentially and extending inward axially along the tire mounting surface 48. It should be appreciated that the grooves 50 may have any suitable shape. It should also be appreciated that steps may be formed in the outer tire mounting surface 48 for a stepped outer shape having a uniform wall thickness.

The shape of the wheel hub of at least one embodiment is particularly suited for molding in an interdigitated mold having at least two mold parts. In order to increase the ease of which the hub 10 is released from the mold, the triangular apertures 44 are tapered inward, becoming narrower toward the front of the hub and the U-shaped apertures 42 are tapered outward, becoming wider toward the front of the hub allowing a first set of a plurality of mold protrusions, or fingers, to form the triangle shaped apertures 44 from the rear of the hub 10 and a second set of a plurality of mold protrusions, or fingers, to form the U-shaped apertures 42 from the front of the hub 10. It should be understood that the shape of the apertures may be any suitable shape and not necessarily U-shaped or triangle shaped. The tapering of the apertures allows for corresponding tapered fingers of the mold which eases release of the hub from the mold components once the hub is formed and allow for the rib 40 to have a constant thickness along the axial width of the hub. A constant rib thickness can be desirable both aesthetically, and mechanically. Likewise, grooves 50 allow for a uniform thickness of the tire mount. A lip 43 is formed on the front edge of the groove 50 providing, inter alia, aesthetic improvement to the hub 10.

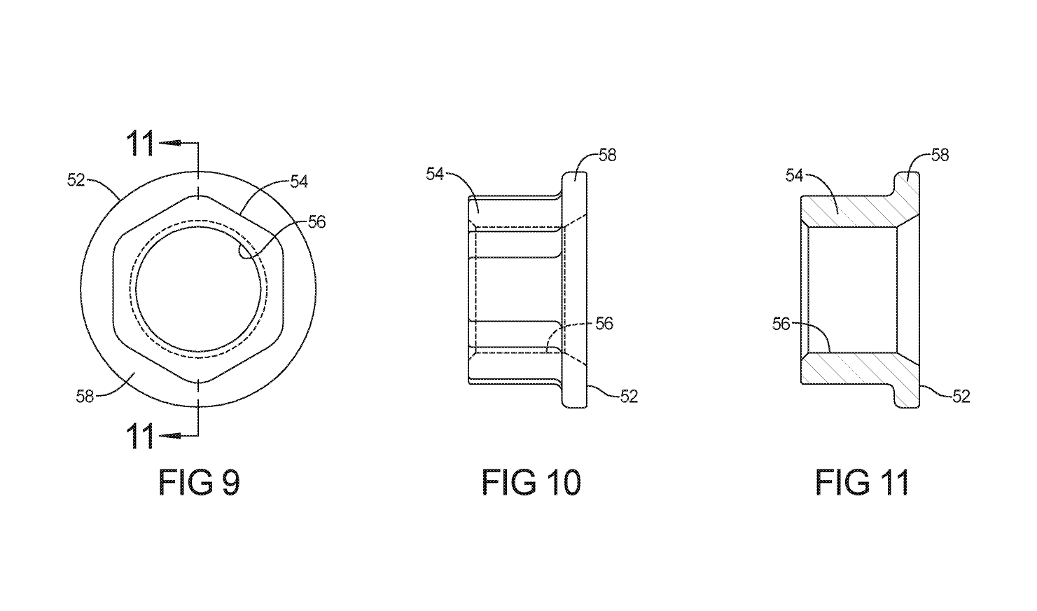

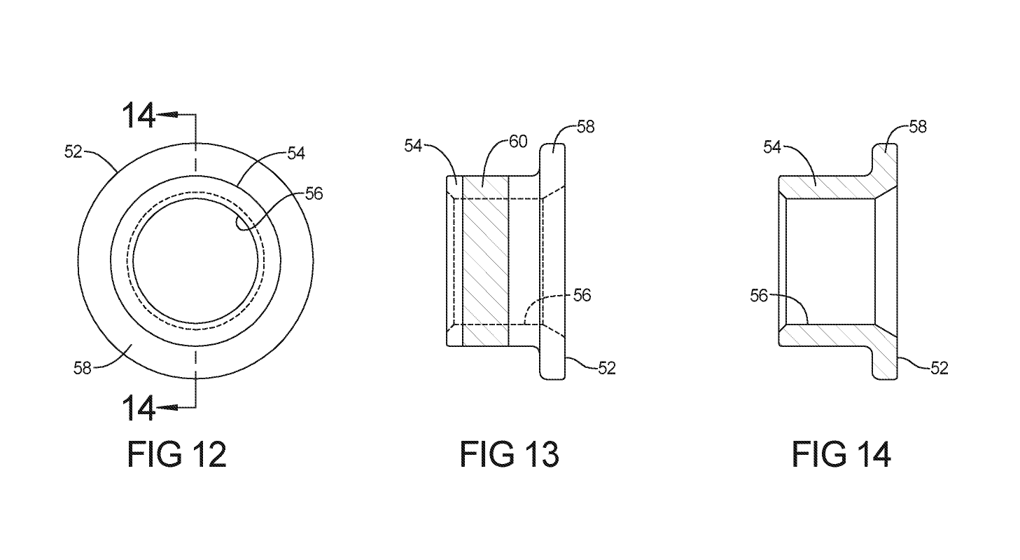

Referring to FIGS. 1 and 1A, the thermoplastic wheel hub 10 further includes a plurality of compression limiters 52, according to the present invention, disposed in the lug apertures 30. As illustrated in FIG. 1A, one of the compression limiters 52 is disposed in one of the lug apertures 30. Referring to FIGS. 9 through 14, each of the compression limiters 52 have a cylindrical body 54 extending axially with an aperture 56 extending axially therethrough to receive a lug 24 of the wheel bearing 20 and a flange 58 extending radially outwardly from the body 54. The body 54 and flange 58 have a shape complementary to the lug apertures 30. In one embodiment illustrated in FIGS. 9 through 11, the flange 58 has a generally circular shape and the body 54 has a non-circular shape such as hexagonal to minimize rotation of the compression limiters 52. In another embodiment illustrated in FIGS. 12 through 14, the flange 58 has a generally circular shape and the body 54 has a generally circular shape with a non-smooth surface 60. The compression limiters 52 are made as one-piece of at least one of a metal, composite, and/or ceramic material. In one embodiment, the compression limiters 52 are overmolded with the center hub 26 to be integral therewith. In another embodiment, the compression limiters 52 are disposed in the lug apertures 30 after the center hub 26 is formed. It should be appreciated that the compression limiters 52 are integral and unitary. It should also be appreciated that, in one embodiment, the lug apertures 30 have a non-circular shape such as hexagonal and the compression limiter 52 have the body 54 with a non-circular shape such as hexagonal to minimize rotation of the compression limiters 52. It should also be appreciated that, in another embodiment, the lug apertures 30 have a circular shape and the compression limiter 52 have the body 54 with a generally circular shape with the non-smooth surface 60 to minimize rotation of the compression limiters 52.

The thermoplastic wheel hub 10 is made of a polymeric material. As such, the thermoplastic wheel hub 10 includes the polymeric material. In one embodiment, the center hub 26, the ribs 40, and the tire mount 46 are made of a polymeric material reinforced by a plurality of fibers ranging from approximately 20% to approximately 65% by weight based on a total weight of the polymeric material. The fibers are at least one of a glass, carbon, mineral, and/or metal material. In one embodiment, the fibers are typically long glass or carbon fibers, short glass or carbon fibers, or a combination of long and short glass and/or carbon fibers. It should be appreciated that the fibers may vary in size (e.g. length, diameter, etc.) and may be coated or uncoated. For example, in one embodiment, the fibers may have an average diameter of less than 13 microns. In other embodiments, the fibers may have an average diameter of 10 microns or less. The polymeric material or the fibers themselves may include other components to encourage bonding between the polymeric material itself and the fibers. An example of suitable fibers for the present invention includes ChopVantage® HP 3660 commercially available from PPG Industries Inc., One PPG Place, Pittsburgh, Pa. 15272.

The polymeric material is at least one selected from the group of polyester, polyamide, polyethylene, polyethylene terephthalate, polyvinyl butyral, acrylonitrile, butadiene styrene, polymethyl methacrylate, cellulose acetate, cyclic olefin copolymers, ethylene vinyl acetate, ethylene vinyl alcohol, fluoropolymers, polyoxymethylene, polyacrylates, polyacrylonitrile, polyaryletherketone, polyamide-imide, polybutadiene, polybutylene terephthalate, polycaprolactone, polycyclohexylene dimethylene, polyhydroxyalkanoates, polyketone, polyetheretherketone, polyetherimide, polycarbonate, polyethylene, polyimide, polylactic acid, polymethylpentene, polyphenylene sulfide, polyphenylene oxide, polyphthalamide, polystyrene, polysulfone, polytrimethylene terephthalate, polyurethane, polyvinyl acetate, polyetherketoneketone, chlorinated polyethylene, polylactic acid, polyvinyl chloride, polyvinylidene chloride, and styrene-acrylonitrile, and combinations thereof.

In one embodiment, the polymeric material is a polyamide, which is typically present in an amount of from about 35 to about 70, more typically from about 45 to about 65, and even more typically from about 50 to about 60 parts by weight based on a total weight of the polymeric material. Although not required, the polyamide is typically selected from the group of polyamide 6, polyamide 6,6, polyamide 46, polyamide 6,10, polyamide 61,6T, polyamide 11, polyamide 12, polyamide 1010, polyamide 6,12, and combinations thereof. However, it should be appreciated that polymeric materials other than polyamides may also be used to manufacture the thermoplastic wheel hub 10. An example of a suitable polyamide for the present invention includes Ultramid® B27 E 01 commercially available from BASF Corporation, 100 Campus Drive, Florham Park, N.J.

In one embodiment, the polymeric material may include an impact modifier for imparting impact resistance to the polymeric material. When employed, the impact modifier is typically present in an amount of from about 1 to about 20, more typically from about 3 to about 12, and even more typically from about 4 to about 10 parts by weight based on a total weight of the polymeric material. The impact modifier is selected from the group of elastomers, ionomers, ethylene copolymers, ethylene-propylene copolymers, ethylene-propylene-diene terpolymers, ethylene-octene copolymers, ethylene-acrylate copolymers, styrene-butadiene copolymer, styrene-ethylene/butylene-styrene terpolymers and combinations thereof. Typically, the impact modifier comprises at least one of ethylene octene, ethylene propylene, and combinations thereof. An example of a suitable impact modifier for the present invention is FUSABOND® grade N493D commercially available from DuPont Company, Lancaster Pike & Route 141, Wilmington, Del. 19805.

In another embodiment, the polymeric material may include ultra-violet (UV) stabilizers, for example, a benzotriazole-type ultraviolet absorber.

In yet another embodiment, the polymeric material may include pre-color pigments. Although not required, the polymeric material may comprise a colorant component for modifying a pigment of the polymeric material. When employed, the colorant component is typically present in an amount of from about 0.01 to about 1, more typically, from about 0.1 to about 0.8, and even more typically from about 0.15 to about 0.4 parts by weight based on a total weight of the polymeric material. An example of a suitable colorant component for the present invention is Orient Nigrosine Base SAPL commercially available from Orient Corporation of America, 1700 Galloping Hill Road, Kenilworth, N.J. 07033. It should be appreciated that the other suitable impact modifiers, UV stabilizers, and pre-color pigments known in the art may be used.

Also provided is a method of making the thermoplastic wheel hub 10. In one embodiment, the thermoplastic wheel hub 10 is made from an injection molding process. In another embodiment, the thermoplastic wheel hub 10 is made from a gas-assisted injection molding process. In yet another embodiment, the thermoplastic wheel hub 10 is made from a microcellular foam injection molding process.

The method generally includes the steps of providing a mold (not shown) which defines a cavity. The cavity may be formed with a deep draw and the direction of draw alternated to achieve uniform walls for the thermoplastic wheel hub 10. With the mold open, the method includes the steps of placing the compression limiters 52 into the cavity of the mold and closing the mold. In one embodiment, the method also includes the steps of injecting polymeric material into the cavity of the mold to form the thermoplastic wheel hub 10 and overmolding the compression limiters 52 to the center hub 26 of the thermoplastic wheel hub 10. Once the thermoplastic wheel hub 10 is formed, the method further includes the steps of opening the mold and removing the thermoplastic wheel hub 10 from the mold. It should be appreciated that the injected molded thermoplastic wheel hub 10 is one-piece.

In another embodiment, the method includes the steps of injecting polymeric material into the cavity of the mold to form the thermoplastic wheel hub 10. Once the thermoplastic wheel hub 10 is formed, the method further includes the steps of opening the mold and removing the thermoplastic wheel hub 10 from the mold. In this embodiment, the method may include the steps of securing the compression limiters 52 to the center hub 26 by ultrasonically welding, push fit, etc. It should be appreciated that the compression limiters 52 may be inserted in a post molding operation. It should also be appreciated that thermoplastic wheel hub 10 may be made by various other methods, not specifically described herein.

The present invention has been described in an illustrative manner. It is to be understood that the terminology, which has been used, is intended to be in the nature of words of description rather than of limitation.

Many modifications and variations of the present invention are possible in light of the above teachings. Therefore, within the scope of the appended claims, the present invention may be practiced other than as specifically described.

What is claimed is:

1-29. (canceled)

30. A non-pneumatic wheel having a front and a rear comprising:
an outer band, the outer periphery of said outer band having a tread for ground contact;
an inner band;
a plurality of web elements positioned between and connecting said outer band and said inner band;
a thermoplastic center hub for attachment to a wheel bearing of a vehicle, said center hub having a central shaft aperture extending axially therethrough and a plurality of lug apertures spaced radially from and circumferentially about said central shaft aperture;
a plurality of thermoplastic ribs extending radially outwardly from said center hub; and
a thermoplastic cylindrical tire mount connected to said ribs and extending axially and substantially parallel to a central axis for mounting said inner band thereon.

31. A non-pneumatic wheel as set forth in claim 30 wherein said outer tire mounting surface includes at least one groove extending radially inward and axially along said tire mounting surface.

32. A non-pneumatic wheel as set forth in claim 30 wherein said tire mount has a substantially uniform wall thickness.

33. A non-pneumatic wheel as set forth in claim 30 wherein a first rib and a second rib of said plurality of said ribs extending between said center hub and said tire mount and spaced from each other to form a first aperture therebetween, said second rib and a third rib of said plurality of said ribs extending between said center hub and said tire mount and spaced from each other to form a second aperture therebetween, wherein said first aperture tapers from said front to said rear and said second rib tapers from said rear to said front, said second rib having a uniform wall thickness.

34. A non-pneumatic wheel as set forth in claim 30 including a plurality of compression limiters disposed in said lug apertures, one of said compression limiters being disposed in one of said lug apertures, wherein each of said compression limiters have a cylindrical body extending axially with an aperture extending axially therethrough to receive a threaded fastener of the wheel bearing and a flange extending radially outwardly from said body, said flange and said body having a shape complementary to said lug apertures.

35. A non-pneumatic wheel as set forth in claim 34 wherein said flange has a circular shape and said body has at least one of a circular shape with a non-smooth surface and a non-circular shape.

36. A non-pneumatic wheel as set forth in claim 34 wherein said compression limiters are made as one-piece of at least one of a metal, composite, and ceramic material.

37. A non-pneumatic wheel as set forth in claim 30 wherein said ribs have a uniform wall thickness.

38. A non-pneumatic wheel as set forth in claim 30 wherein said center hub, said ribs, and said tire mount are made of a polymeric material reinforced by a plurality of fibers ranging from approximately 20% to approximately 65% by weight based on a total weight of the polymeric material.

39. A non-pneumatic wheel as set forth in claim 38 wherein said fibers are at least one of a glass, carbon, mineral, and metal material.

40. A non-pneumatic wheel as set forth in claim 38 wherein said fibers are long glass or carbon fibers, short glass or carbon fibers, or a combination of long and short glass and/or carbon fibers.

41. A non-pneumatic wheel as set forth in claim 38 wherein said polymeric material is at least one selected from the group of polyester, polyamide, polypropylene, polyethylene terephthalate, polyvinyl butyral, acrylonitrile, butadiene styrene, polymethyl methacrylate, cellulose acetate, cyclic olefin copolymers, ethylene vinyl acetate, ethylene vinyl alcohol, fluoropolymers, polyoxymethylene, polyacrylates, polyacrylonitrile, polyaryletherketone, polyamide-imide, polybutadiene, polybutylene terephthalate, polycaprolactone, polycyclohexylene dimethylene, polyhydroxyalkanoates, polyketone, polyetheretherketone, polyetherimide, polycarbonate, polyethylene, polyimide, polylactic acid, polymethylpentene, polyphenylene sulfide, polyphenylene oxide, polyphthalamide, polystyrene, polysulfone, polytrimethylene terephthalate, polyurethane, polyvinyl acetate, polyetherketoneketone, chlorinated polyethylene, polylactic acid, polyvinyl chloride, polyvinylidene chloride, and styrene-acrylonitrile, and combinations thereof.

42. A non-pneumatic wheel as set forth in claim 38 wherein said polymeric material includes impact modifiers.

43. A non-pneumatic wheel as set forth in claim 38 wherein said polymeric material includes ultra-violet (UV) stabilizers.

44. A non-pneumatic wheel as set forth in claim 30 wherein said thermoplastic wheel hub is made from an injection molding process.

45. A non-pneumatic wheel as set forth in claim 30 wherein said thermoplastic wheel hub is made from a gas-assisted injection molding process.

46. A non-pneumatic wheel as set forth in claim 30 wherein said thermoplastic wheel hub is made from a microcellular foam injection molding process.

47. A non-pneumatic wheel having a front and a rear comprising:
an outer band, said outer band having a tread for ground contact;
an inner band;
a plurality of web elements positioned between and connecting said outer band and said inner band;
a thermoplastic center hub for attachment to a wheel bearing of a vehicle, said center hub comprising a base wall extending radially and a side wall extending circumferentially and axially about said base wall, a central shaft aperture extending axially though said base wall and a plurality of lug apertures spaced radially from and circumferentially about said central shaft aperture and extending axially through said base wall and said side wall;
a plurality of thermoplastic ribs extending radially outwardly from said side wall and spaced circumferentially about said center hub, said ribs having a uniform wall thickness;
a thermoplastic cylindrical tire mount connected to said ribs and extending axially in substantially a cylinder such that said center hub is recessed relative to an outer axial periphery of said tire mount and cantilevered by said ribs to said tire mount, said tire mount having a substantially uniform wall thickness and a non-smooth outer tire mounting surface for mounting a non-pneumatic tire thereon;
a plurality of compression limiters disposed in said lug apertures, one of said compression limiters being disposed in one of said lug apertures, each of said compression limiters having a cylindrical body extending axially with an aperture extending therethrough to receive a threaded fastener of the wheel bearing and being integral, unitary, and one-piece; and
said center hub, said ribs, and said tire mount are made of a polymeric material reinforced by a plurality of fibers to be integral, unitary, and one-piece and said compression limiters being made as one-piece of at least one of a metal, composite, and ceramic material and secured to said center hub to be integral therewith.
